(19) United States
(12) Patent Application Publication
(10) Pub. No.: US 2025/0140022 A1
(43) Pub. Date: May 1, 2025

(54) ACTION RECOGNITION DEVICE, ACTION RECOGNITION METHOD, AND NON-TRANSITORY COMPUTER READABLE RECORDING MEDIUM

(71) Applicant: Panasonic Intellectual Property Corporation of America, Torrance, CA (US)

(72) Inventors: Nobuhiko WAKAI, Tokyo (JP); Shigehiro IIDA, Tokyo (JP)

(73) Assignee: Panasonic Intellectual Property Corporation of America, Torrance, CA (US)

(21) Appl. No.: 19/011,120

(22) Filed: Jan. 6, 2025

Related U.S. Application Data
(63) Continuation of application No. PCT/JP2022/048526, filed on Dec. 28, 2022.

(30) Foreign Application Priority Data
Jul. 7, 2022 (JP) 2022-109937

(51) Int. Cl. G06V 40/20; G06T 7/73

(52) U.S. Cl. CPC G06V 40/20; G06T 7/73

(57) ABSTRACT

An action recognition device performs: estimating node coordinates of a user from an image; calculating, on the basis of the node coordinates, time-series feature vectors each indicating a feature vector connecting a trunk of the user and a head of the user to each other in time series; deciding an action of the user and a change in the action of the user by comparing input time-series feature vectors being the calculated time-series feature vectors with reference time-series feature vectors; and outputting information indicating the action and the change in the action that are decided.

### FIELD OF INVENTION

The present disclosure relates to a technology of recognizing an action of a user from an image.

### BACKGROUND ART

For instance, Patent Literature 1 and Patent Literature 2 have been known to each disclose a technology of recognizing an action of a user by using an image, such as a still image and a video image. Patent Literature 1 has an object of determining a fatigue degree of a person, and discloses a technology of extracting time-series data of a node of a person on the basis of a video image captured by photographing a target user and determining the fatigue degree on the basis of an arm swinging state and a foot fluctuation of the user. Patent Literature 2 has an object of determining a walking state and an age of a walking person, and discloses a technology of detecting time-series data about a specific portion of a person on the basis of a video image captured by photographing a target user, and calculating a walking state of the person and a classification of a walking velocity of the person.

Unfortunately, each of the conventional action recognition technologies as described above has a drawback of a failure at recognizing, with a high accuracy, an action of a user to be recognized from an image not covering a whole body of the user due to an obstacle or other object.
Patent Literature 1: Japanese Patent Publication No. 6873344
Patent Literature 2: Japanese Patent Publication No. 3655618

### SUMMARY OF THE INVENTION

This disclosure has been accomplished to solve the drawback described above, and has an object of providing a technology of recognizing, with high accuracy, an action of a user to be recognized even from an image not covering a whole body of the user.

An action recognition device according to one aspect of this disclosure is an action recognition device that recognizes an action of a user. The action recognition device includes: an acquisition part that acquires an image; an estimation part that estimates node coordinates of the user from the image acquired by the acquisition part; a calculation part that calculates, on the basis of the node coordinates, time-series feature vectors each indicating a feature vector connecting a trunk of the user and a head of the user to each other in time series; a storage part that stores reference time-series feature vectors being the time-series feature vectors to be a reference; and a decision part that decides the action of the user and a change in the action of the user by comparing input time-series feature vectors being time-series feature vectors calculated by the calculation part with the reference time-series feature vectors.

This disclosure achieves recognition of an action of a user with a high accuracy even from an image not covering a whole body.

### BRIEF DESCRIPTION OF THE DRAWINGS

FIG. 1 is a block diagram showing an example of a configuration of an action recognition system in an embodiment of the disclosure.

FIG. 2 is an illustration of an example of node information showing node coordinates estimated by an estimation part.

FIG. 3 is a flowchart showing an example of a process by an action recognition device in the embodiment of the disclosure.

FIG. 4 is an illustration of a feature vector calculated from an image captured by photographing a user in a sitting action.

FIG. 5 is a flowchart showing details of comparison in step S7 in FIG. 3.

FIG. 6 includes graphs, each showing a chronological change of a vector length of a feature vector under two different sitting conditions imposed on a subject for an action label “sitting”.

### DETAILED DESCRIPTION

Hereinafter, an embodiment of the present invention will be described with reference to the accompanying drawings. It should be noted that the embodiment illustrates one specific example of the present invention, and does not delimit the protection scope of the present invention.

Knowledge forming the basis of the present disclosure

In recent years, a way of estimating a node of a person from an image and recognizing an action of a user on the basis of the estimated node has been known. The recognition way adopts an image captured by photographing a whole body of the user at a camera angle suitable for sensing and images captured by photographing a walking state of the user for a long time. The recognition way further includes estimating a node via a deep neural network including a convolutional layer and a pooling layer to increase the accuracy.

Meanwhile, a technology of detecting a change in an action of a user in a daily life has been expected in recent years to detect a physical decline. Unfortunately, in such a daily life, some obstacle may hide a part of the body of the user whose action is to be recognized or a part of the body may not be covered in an image. The conventional recognition way hence has a drawback of a failure at recognizing an action of a user with a high accuracy at photographing the user in the action under an unfavorable photographing condition. In particular, this drawback is likely to be seen in a residence having a restriction on an arrangement position for the camera.

This disclosure has been conceived in consideration of the drawback described above, and provides a technology of recognizing a user to be recognized with a high accuracy even in a case of a failure at photographing a whole body of the user.

(1) An action recognition device according to one aspect of the present disclosure is an action recognition device that recognizes an action of a user. The action recognition device includes: an acquisition part that acquires an image; an estimation part that estimates node coordinates of the user from the image acquired by the acquisition part; a calculation part that calculates, on the basis of the node coordinates, time-series feature vectors each indicating a feature vector connecting a trunk of the user and a head of the user to each other in time series; a storage part that stores reference time-series feature vectors being the time-series feature vectors to be a reference; and a decision part that decides the action of the user and a change in the action of the user by comparing input time-series feature vectors being the time-series feature vectors calculated by the calculation part with the reference time-series feature vectors.

In this configuration, an action of the user and a change in the action of the user are decided by comparing input time-series feature vectors with reference time-series feature vectors. Here, each of the input time-series feature vectors and the reference time-series feature vectors constitutes a feature vector connecting the trunk of the user and the head of the user to each other. The feature vector is generatable on the basis of information about an upper body of the user and does not largely fluctuate depending on a camera angle. This configuration hence enables recognition of the action of the user to be recognized with a high accuracy even from an image not covering a whole body of the user.

(2) In the action recognition device according to (1), in the comparing by the decision part, a feature vector constituting the input time-series feature vectors may be compared with a feature vector constituting the reference time-series feature vectors in terms of one of a length of the vector, an angle of the vector, a chronological change of the length, and a chronological change of the angle.

In this configuration, each input time-series feature vector is compared with each reference time-series feature vector by using one of a length of a feature vector of the input time-series feature vector and a feature vector of the reference time-series feature vector, an angle of the vector, a chronological change of the length, and a chronological change of the angle. The configuration thus enables recognition of the action of the user with a high accuracy.

(3) In the action recognition device according to (1) or (2), the time-series feature vectors may be normalized in such a manner that a time is a reference value.

In this configuration, each of the input time-series feature vectors and the reference time-series feature vectors is normalized in such a manner that a time is a reference value, and thus, the configuration facilitates the comparison between the input time-series feature vectors and the reference time-series feature vectors.

(4) The action recognition device according to any one of (1) to (3), the node coordinates estimated by the estimation part may include reliability indicating an estimation accuracy. The calculation part may calculate a coordinate of the trunk and a coordinate of the head by weighting the node coordinates by using the reliability, and calculate the feature vector on the basis of the calculated coordinate of the trunk and the calculated coordinate of the head.

This configuration enables calculation of a feature vector in consideration of reliability of the node coordinates.

(5) In the action recognition device according to any one of (1) to (4), the reference time-series feature vectors may include a plurality of first reference time-series feature vectors each associated with an action label indicating a kind of an action. The decision part may decide an action label showing the action of the user by comparing the input time-series feature vectors with the first reference time-series feature vectors, and calculate an average time-series feature vector by averaging the first reference time-series feature vectors associated with the decided action label, and decide a change in the action of the user by comparing the input time-series feature vectors with the average time-series feature vectors.

In this configuration, the action label is decided by comparing the input time-series feature vectors with the first reference time-series feature vectors associated with the action label, and thus, the configuration enables decision on the action of the user with a high accuracy. Besides, a change in the action of the user is decided by comparing the input time-series feature vectors with the average time-series feature vector resulting from averaging the first reference time-series feature vectors associated with the decided action label. The configuration hence enables one-to-one comparison between the input time-series feature vectors and the first reference time-series feature vectors.

(6) In the action recognition device according to any one of (1) to (5), a feature vector calculated by the calculation part may indicate a coordinate of the trunk and a coordinate of the head by using coordinates of the image. The decision part may execute a parallel translation of the feature vector so that the coordinate of the trunk on the feature vector calculated by the calculation part meets an origin of a coordinate system of the image, and show the time-series feature vectors by using the feature vector obtained by the parallel translation.

In this configuration, a parallel translation of the feature vector is executed so that a start point of the feature vector calculated by the calculation part meets an origin of the coordinate system of the image, and thus, the configuration enables comparison between feature vectors regardless of positions on the image where the feature vectors come into existence.

(7) The action recognition device according to any one of (1) to (6), the decision part may normalize feature vectors so that each of a vertical length and a horizontal length of the image has 1, and show the time-series feature vectors by using the normalized feature vectors.

This configuration enables comparison between feature vectors acquired from images having different sizes with a high accuracy.

(8) In the action recognition device according to any one of (1) to (7), in a case where a period during which time-series feature vectors are continuously calculated is not shorter than a predetermined period, the calculation part may determine the feature vectors within the period as the input time-series feature vectors.

This configuration enables decision of time-series feature vectors formed of a series of feature vectors representing an action as the input time-series feature vectors, and thus enables recognition of the action of the user with a high accuracy.

(9) In the action recognition device according to any one of (1) to (8), the reference time-series feature vectors may represent input time-series feature vectors calculated by the calculation part in past.

In this configuration, the input time-series feature vectors calculated in past serve as reference time-series feature vectors, and thus, the configuration facilitates collecting of the reference time-series feature vectors. Besides, past input time-series feature vectors are compared with current time-series feature vectors, and thus, the configuration enables accurate decision on a change in the action from an action in past.

(10) In the action recognition device according to any one of (1) to (9), the reference time-series feature vectors and the input time-series feature vectors may belong to the same user.

This configuration enables detection of a change from a past action of the user to a current action of the user.

(11) The action recognition device according to any one of (1) to (10), the decision part may decide an occurrence of a change in the action of the user when a statistical value of correlations between feature vectors of the input time-series feature vectors and feature vectors of the reference time-series feature vectors in time-series association exceeds a threshold.

In this configuration, an occurrence of a change in the action of the user is decided when the statistical value of a difference between the input time-series feature vectors and the reference time-series feature vectors exceeds the threshold, and thus, the configuration enables decision on the change in the action of the user with a high accuracy.

(12) The action recognition device according to any one of (1) to (11) may further include an output part that outputs the action and the change in the action that are decided by the decision part.

The configuration enables outputting of the action and the change in the action that are decided.

(13) An action recognition method according to another aspect of the present disclosure is an action recognition method for an action recognition device that recognizes an action of a user. The action recognition method includes: acquiring an image; estimating node coordinates of the user from the acquired image; calculating, on the basis of the node coordinates, time-series feature vectors each indicating a feature vector connecting a trunk of the user and a head of the user to each other in time series; and deciding the action of the user and a change in the action of the user by comparing input time-series feature vectors being the calculated time-series feature vectors with reference time-series feature vectors being the time-series feature vectors to be a reference.

This configuration makes it possible to provide an action recognition method that exerts operational effects equivalent to those of the action recognition device described above.

(14) An action recognition program according to further another aspect of the disclosure is an action recognition program for causing a computer to serve as an action recognition device that recognizes an action of a user. The program causes the computer to execute: acquiring an image; estimating node coordinates of the user from the acquired image; calculating, on the basis of the node coordinates, time-series feature vectors each indicating a feature vector connecting a trunk of the user and a head of the user to each other in time series; and deciding the action of the user and a change in the action of the user by comparing input time-series feature vectors being the calculated time-series feature vectors with reference time-series feature vectors being the time-series feature vectors to be a reference.

This configuration makes it possible to provide an action recognition program that exerts operational effects equivalent to those of the action recognition device described above.

(15) A recording medium according to still another aspect of the disclosure is a non-transitory computer readable recording medium for recording an action recognition program for causing a computer to serve as an action recognition device that recognizes an action of a user. The recording medium includes causing the computer to execute: acquiring an image; estimating node coordinates of the user from the acquired image; calculating, on the basis of the node coordinates, time-series feature vectors each indicating a feature vector connecting a trunk of the user and a head of the user to each other in time series; and deciding the action of the user and a change in the action of the user by comparing input time-series feature vectors being the calculated time-series feature vectors with reference time-series feature vectors being the time-series feature vectors; and outputting information indicating the action and the change in the action that are decided.

This disclosure can be realized as an action recognition system caused to operate by the action recognition program as well. Additionally, it goes without saying that the computer program is distributable as a non-transitory computer readable storage medium like a CD-ROM, or distributable via a communication network like the Internet.

Each of the embodiments which will be described below represents a specific example of the disclosure. Numeric values, shapes, constituent elements, steps, and the order of the steps described below in each embodiment are mere examples, and thus should not be construed to delimit the disclosure. Moreover, constituent elements which are not recited in the independent claims each showing the broadest concept among the constituent elements in the embodiments are described as selectable constituent elements. The respective contents are combinable with each other in all the embodiments.

### Embodiment

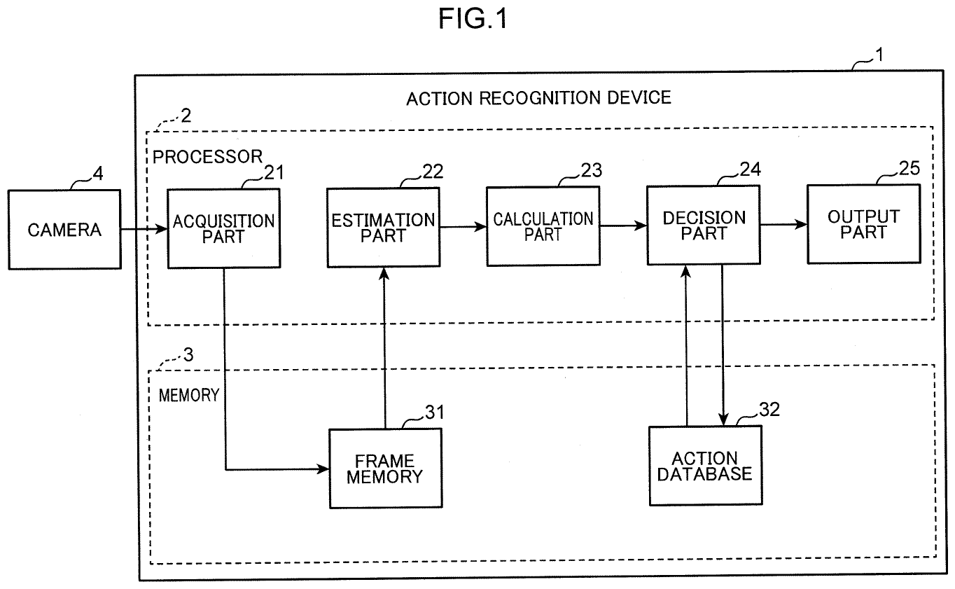

Hereinafter, an embodiment of the disclosure will be described with reference to the accompanying drawings. FIG. 1 is a block diagram showing an example of a configuration of an action recognition system in an embodiment of the disclosure. The action recognition system includes an action recognition device 1 and a camera 4. The camera 4 is a photographing device that captures an image of an action of a user (hereinafter, referred to as a “target user”) whose action is to be recognized. For instance, the camera 4 corresponds to a fixed camera provided in a residence where the user lives, but is not particularly limited thereto. The camera 4 captures an image of the user at a predetermined frame rate, and inputs the captured image into the action recognition device 1 at a predetermined frame rate. The action recognition device 1 is aimed at deciding a change in an action of the target user by using the image captured by the camera. The action recognition device 1 is composed of a computer including a processor 2, a memory 3, and an interface circuit (not shown).

The processor 2 includes hardware for deciding a change in the action of the target user on the basis of the image, for example, a central processing unit. The processor 2 has an acquisition part 21, an estimation part 22, a calculation part 23, a decision part 24, and an output part 25. Each of the acquisition part 21 to the output part 25 may come into effect when the central processing unit executes the action recognition program, or may be established in the form of a dedicated hardware circuit, such as an application specific integrated circuit (ASIC).

The memory 3 is a storage device that records an action of the target user acquired from the image, that is, includes a non-volatile storage device, for example, a flash memory, a hard disk drive, and a solid state drive. The interface circuit is an input and output mechanism for data, and includes, for example, a communication circuit.

The memory 3 has a frame memory 31 and an action database 32. The frame memory 31 stores an image acquired by the acquisition part 21 from the camera 4. The action database 32 is a database that stores input time-series feature vectors calculated from images of the target user in past as reference time-series feature vectors. Specifically, the action database 32 stores a plurality of action labels each indicating a kind of an action to be a decisive candidate and a plurality of reference time-series feature vectors each associated with corresponding one of the action labels in association with each other. The reference time-series feature vector represent time-series feature vectors each to be a reference for comparison with input time-series feature vectors in time series to calculate a change in the action of the user. Examples of the action to be a decisive candidate include various actions which the user is highly likely to take in the residence, such as walking, sitting, standing up, and stooping.

The acquisition part 21 acquires an image captured by the camera 4 and inputs the acquired image into the frame memory 31. The frame memory 31 stores each image input from the acquisition part 21.

The estimation part 22 reads out an image from the frame memory 31 and estimates a plurality of node coordinates of the target user and reliability of each of the node coordinates on the basis of the read image. Each node coordinate represents a coordinate in an image coordinate system of a node of the target user detected from the image.

The reliability is a value indicating a certainty of estimation for each node coordinate and expresses the certainty of the estimated node coordinate with a probability. The certainty increases as a value of the reliability of the node coordinate increases. The reliability takes, for example, a value falling within a range from 0 to 1.

The estimation part 22 estimates each of the node coordinates and the reliability thereof by inputting the image into a learned model obtained through machine learning of a relation between the image and the node coordinate. An example of the learned model is a deep neural network. An example of the deep neural network is a convolutional neural network including a convolutional layer and a pooling layer. The estimation part 22 may include a learning model other than the deep neural network.

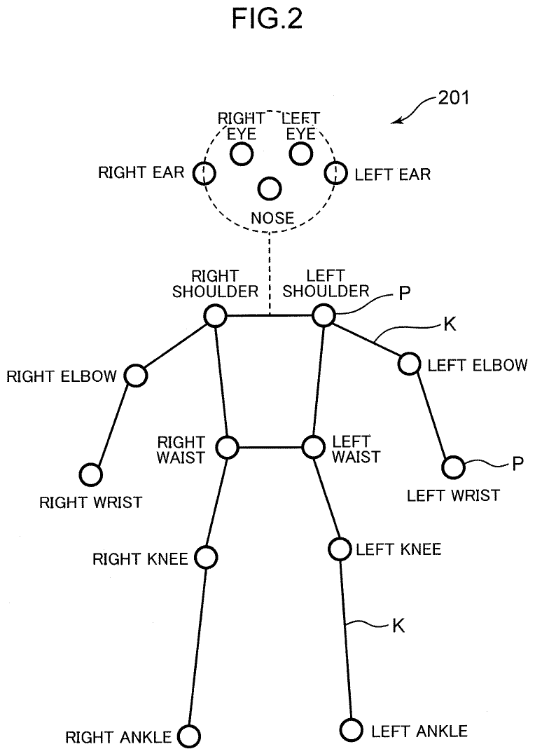

FIG. 2 is an illustration of an example of node information 201 showing node coordinates P estimated by the estimation part 22. In FIG. 2, dashed lines represent auxiliary lines respectively denoting an outline of a face and a location of a neck.

The node information 201 includes information about node coordinates P of one target user. The node information 201 shows, for example, seventeen node coordinates P respectively showing a left eye, a right eye, a left ear, a right ear, a nose, a left shoulder, a right shoulder, a left waist, a right waist, a left elbow, a right elbow, a left wrist, a right wrist, a left knee, a right knee, a left ankle, and a right ankle. The learned model is configured to estimate each of the seventeen node coordinates P. In the example shown in FIG. 2, the node information 201 shows the seventeen node coordinates P, but this is just an example. The number of node coordinates P may be sixteen or smaller, or may be eighteen or larger. In this case, the learned model may be configured to estimate a predetermined number of node coordinates P that is sixteen or smaller, or eighteen or larger. Furthermore, the node information 201 may show other node coordinates (e.g., node coordinates of a finger, a mouth, and other parts) in addition to the node coordinates P shown in FIG. 2.

The node information 201 further shows links K linking the node coordinates P to each other. Each of the node coordinates P is expressed by an X-coordinate being a horizontal component in the image and a Y-coordinate being a vertical component in the image. The node information 201 is expressed by an indicator uniquely specifying each node coordinate P, the node coordinate P, and reliability of the node coordinate P. For instance, the node information 201 is expressed in a dictionary format, such as {an indicator “right eye”: [X-coordinate, Y-coordinate, reliability], an indicator “left eye”: [X-coordinate, Y-coordinate, reliability], . . . an indicator “left ankle”: [X-coordinate, Y-coordinate, reliability]}

The calculation part 23 calculates, on the basis of the node coordinates P estimated by the estimation part 22, time-series feature vectors. Hereinafter, the time-series feature vectors are referred to as input time-series feature vectors. The input time-series feature vector include a plurality of feature vectors arranged in time series. Each of the feature vectors is a two-dimensional vector connecting a trunk of a target user as a start point to a head of the target user as a finish point. The feature vector is expressed with a vector by subtracting a coordinate of the finish point from a coordinate of the start point. This is just an example, and the feature vector may be expressed with a vector by extracting the coordinate of the start point from the coordinate of the finish point.

The decision part 24 decides an action of the target user and a change in the action of the target user by comparing the input time-series feature vectors calculated by the calculation part 23 with the reference time-series feature vectors stored in the action database 32. The decision will be described in detail later. The decision part 24 may express a change in an action by a Boolean value, that is, a true or false value. However, this is just an example, and the decision part 24 may calculate a numeric value indicating a difference between the input time-series feature vectors and the reference time-series feature vectors as a change in the action of the target user. The Boolean value shows “true” in accordance with a change in an action and “false” in accordance with no change in the action.

The reference time-series feature vectors to be compared with the input time-series feature vectors represent input time-series feature vectors of the target user calculated in past by the calculation part 23, for example, calculated a half-year before. However, this is just an example, and the reference time-series feature vectors to be compared with the input time-series feature vectors may represent time-series feature vectors of another user who is at the same age as the target user, or may represent time-series feature vectors each indicating a reference walk stored in advance.

The output part 25 outputs information indicating the action and the change in the action that are decided by the decision part 24. Example cases in which a difference is seen in an action of a target user include a case where a sitting action taken a half-year before differs from a current sitting action and a case where a difference is seen in the action of the target user due to a physical decline attributed to aging or an injury. The output part 25 may send the information to a computer carried by the target user via an input and output interface, or may store the information in a storage device.

For instance, the action recognition device 1 may include an edge server provided in the residence, may include a smart speaker provided in the residence, or may include a cloud server. When the action recognition device 1 includes the edge server, the camera 4 and the action recognition device 1 are connected to each other via a local area network. When the action recognition device 1 includes a cloud server, the camera 4 and the action recognition device 1 are connected to each other via a wide area network like the internet. Here, constituent elements of the action recognition device 1 may be separately arranged in such a manner that a part of the constituent elements is provided on the edge server and the remaining part of the constituent elements is provided on the cloud server.

The action recognition device 1 may not be necessarily achieved by a single computer device, but may be achieved by a decentralization system (not shown) including a terminal device and a server. For example, the acquisition part 21, the frame memory 31, and the estimation part 22 may be provided in the terminal device, whereas the action database 32, the calculation part 23, the decision part 24, and the output part 25 may be provided on the server. In this example, the constituent elements transfer data therebetween via a wide area network.

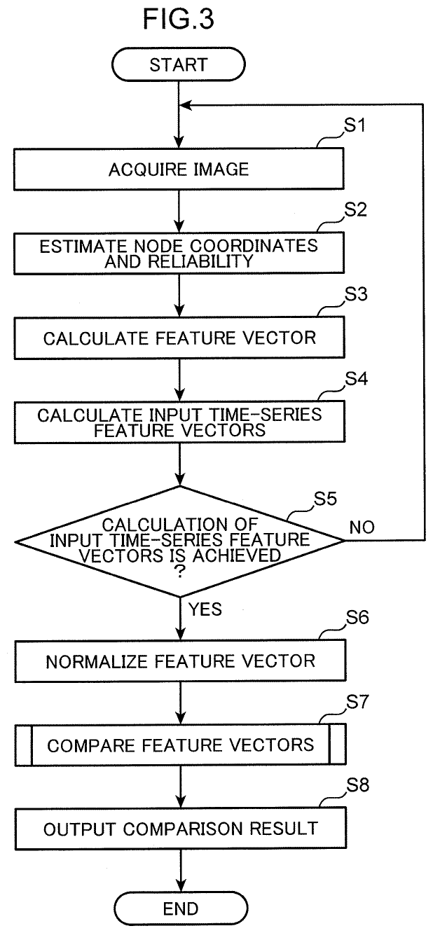

Heretofore, the configuration of the action recognition device 1 has been described. Next, a process by the action recognition device 1 will be described. FIG. 3 is a flowchart showing an example of the process by the action recognition device 1 in the embodiment of the disclosure.

### Step S1

The acquisition part 21 acquires an image from the camera 4 and stores the acquired image in the frame memory 31. The acquisition part 21 may always acquire an image or may periodically acquire an image from the camera 4.

### Step S2

The estimation part 22 acquires a plurality of images in time series from the frame memory 31, and estimates a plurality of node coordinates P in each image and reliability of each of the node coordinates P by inputting the acquired images into a learned model one after another. Consequently, time-series data of the node coordinates P and the reliability is obtained. The estimation part 22 may trace the target user with the time-series data. For instance, the estimation part 22 may calculate gravity centers of bounding rectangles concerning the node coordinates P in respective continuous time-series images, and associate a bounding rectangle having the gravity center closest to the gravity center of another bounding rectangle with each other to determine that the bounding rectangles belong to the same user, resulting in tracing the target user. In this manner, the configuration enables, even in a case where an image shows a plurality of target users, tracing of the target users individually. The estimation part 22 may associate bounding rectangles in adjacent images with each other by the Hungarian notation. In a case of a plurality of gravity centers respectively in adjacent images, a set of gravity centers at a shortest distance therebetween can be determined by the Hungarian notation.

Although an image is described to show one target user in the embodiment, this is an example, and an image may show a plurality of target users. In this case, the action recognition device 1 may estimate node coordinates P and reliability of each of the node coordinate P for each of the target users individually, and a change in an action of each target user may be decided in accordance with an associated result of the estimation.

### Step S3

The calculation part 23 calculates, from the node coordinates P acquired in step S2, a feature vector having a start point at the trunk of the target user and a finish point at the head of the target user.

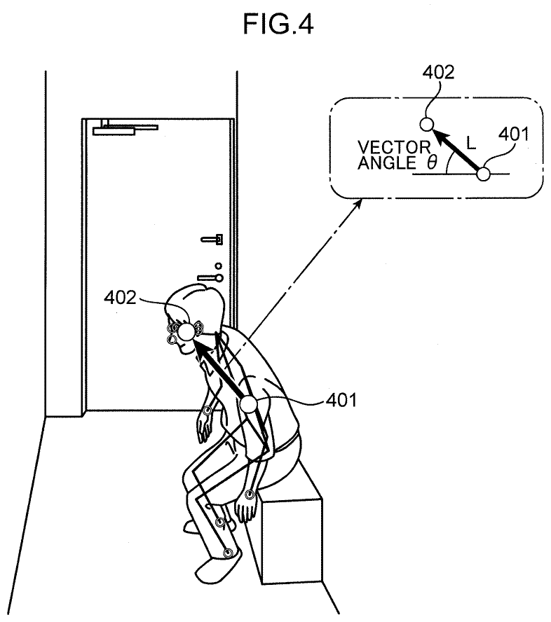

FIG. 4 is an illustration of a feature vector calculated from an image captured by photographing a user in a sitting action. As illustrated in FIG. 4, a feature vector L is a two-dimensional vector representing a posture of an upper body of the target user. The feature vector L has a start point 401 at the gravity center of the trunk, and the feature vector L has a finish point 402 at the gravity center of the head. The start point 401 indicates a gravity center coordinate of, for example, four node coordinates P in total of two coordinates of both the shoulders and two coordinates of both the waists, the shoulders and waists belonging to the trunk. The finish point 402 indicates a gravity center coordinate of, for example, five node coordinates P in total of two coordinates of both the ears, two coordinates of both the eyes, and one coordinate of the nose.

The calculation part 23 may exclude such a node coordinate P as not detected due to, for example, an obstacle and an orientation of the body from the calculation of the feature vector L to increase an accuracy of estimating the feature vector L. In this case, the calculation part 23 may calculate each of the start point 401 and the finish point 402 by using only a detected node coordinate P. The calculation part 23 may avoid calculating the feature vector L at no detection of a node coordinate P which is necessary for the calculation of the start point 401 or the finish point 402 from the acquired image. In this case, the calculation part 23 may record a missing value indicating no feature vector L in place of the feature vector L. In this manner, the calculation part 23 can calculate a group of feature vectors L in a period excluding the missing value as input time-series feature vectors.

The calculation part 23 may calculate the gravity center of the trunk or the head by weighting and averaging the node coordinates P belonging to the trunk or the head by the reliability of each node coordinate. The calculation part 23 may calculate the gravity center of a bounding rectangle including the node coordinates P as the start point 401 or the finish point 402 in place of the gravity center of the trunk or the head. The node coordinates P for use in calculation of the gravity center of the trunk or the head are not limited to the node coordinates P described above, and other node coordinate P may be added. For instance, the calculation part 23 may calculate the start point 401 by further using the node coordinates P of both the knees.

### Step S4

The calculation part 23 calculates input time-series feature vectors by extracting, from among feature vectors L calculated in step S3, feature vectors L in a predetermined period from a current time to a certain past time. The predetermined period indicates, for example, ten seconds, but is not particularly limited thereto. The predetermined period may show a plurality of actions. In this case, the calculation part 23 may extract feature vectors L for each of the actions. Specifically, when a predetermined period includes a subperiod during which feature vectors L are continuously calculated for a period of threshold (e.g., two seconds) or longer, the calculation part 23 may define the subperiod as a valid subperiod showing an action and calculate time-series data about the feature vectors L in the valid subperiod to be input time-series feature vectors. The calculation part 23 may define a missing subperiod for which the missing value is recorded in step S3 as a boundary of the valid subperiod. Thus, when the predetermined period shows a plurality actions taken by the user, valid subperiods associated with the actions are extracted, and input time-series feature vectors for each of the valid subperiods are calculated. This leads to achieved calculation of input time-series feature vectors for the valid subperiod of the threshold or longer and enables accurate specification of the action of the user. For instance, in an entrance hall, an action of stooping to wear shoes and an action of stooping to take a shoe brush lying on the floor are distinguished from each other to enable decision on a change in the action. This results in attaining detailed analysis of the action of the user. Specifically, in calculation of a plurality of input time-series feature vectors in a predetermined period in the embodiment, a change in an action is decided for each of the input time-series feature vectors. An operator having viewed an image may manually designate extraction of a predetermined period and a valid subperiod.

### Step S5

The calculation part 23 leads the process to step S6 when calculation of the input time-series feature vectors in the predetermined period in step S4 is achieved (YES in step S5), and returns the process to step S1 by determining that the predetermined period does not show an action of the target user when the calculation of the input time-series feature vectors is failed (NO in step S5).

### Step S6

The calculation part 23 normalizes each of the input time-series feature vectors in such a manner that a time for each of the input time-series feature vectors calculated in step S4 is a reference value (e.g., 1). Although a time required for a motion may differ in a specific action, the normalization allows a time scale for input time-series feature vectors and a time scale for reference time-series feature vectors to agree with each other, and thus facilitates comparison between the input and reference time-series vectors. For example, an action is defined to come to a peak at the middle of a valid subperiod. In this example, an action in four seconds for input time-series feature vectors comes to a peak at a position of two seconds, and an action in six seconds for reference time-series feature vectors comes to a peak at a position of three seconds. In this regard, the forementioned normalization makes respective peaks about the input and reference time-series vectors reach a position of 0.5, and thus facilitates comparison between the input and reference time-series feature vectors.

The normalization is not limited thereto. The calculation part 23 may execute a parallel translation of the feature vector L so that the start point 401 of the feature vector L constituting each input time-series feature vector meets an origin of an image coordinate system. The normalization of the feature vector L leads to achieved calculation of the feature vector L without an influence of a position where the target user acts. For example, a position of a feature vector L in an image showing stooping at the center of a hallway differs from a position of a feature vector L in an image showing stooping at a right end of the hallway. In this regard, normalization of executing the parallel translation of a feature vector L so that the start point 401 of the feature vector L meets the origin results in achieved comparison between the feature vector L at the center of the hallway and the feature vector L at the right end of the hallway regardless of the positional difference between these feature vectors L. This facilitates the comparison between the feature vectors L. The calculation part 23 may normalize each feature vector L so that each of a horizontal length and a vertical length of an image has a reference value (e.g., “1”). This enables comparison between feature vectors L shown in images respectively captured by cameras having different solutions.

### Step S7

The decision part 24 compares the input time-series feature vectors normalized in step S6 with normalized reference time-series feature vectors stored in the action database 32. Hereinafter, step S7 will be described in detail.

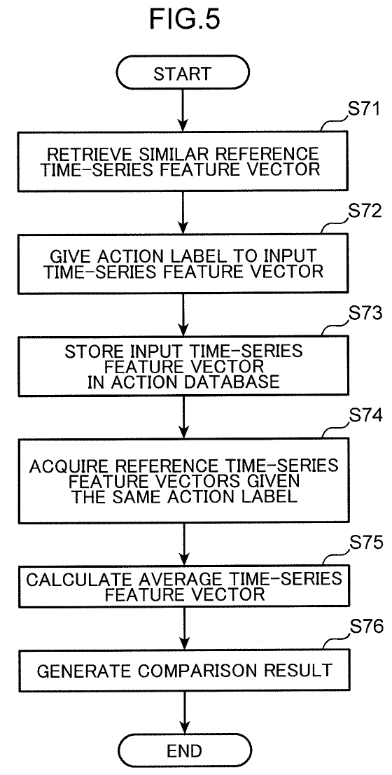

FIG. 5 is a flowchart showing details of comparison in step S7 in FIG. 3.

### Step S71

The decision part 24 retrieves a reference time-series feature vector that is most similar to each input time-series feature vector normalized in step S6 from among all the reference time-series feature vectors stored in the action database 32. Specifically, the decision part 24 may calculate feature vector distances between input time-series feature vectors and the reference time-series feature vectors, and retrieve a reference time-series feature vector at the shortest feature vector distance among the calculated feature vector distances to be a most similar reference time-series feature vector.

Each feature vector distance is calculated as follows. First, the decision part 24 extracts feature vectors L concerning a predetermined number of frames respectively from the input time-series feature vectors and the reference time-series feature vectors. The predetermined number of frames may be an appropriate number of frames, for example, all the frames, or ten frames. Here, each feature vector L from the input time-series feature vectors is defined as a first feature vector, and each feature vector L from the reference time-series feature vectors is defined as a second feature vector. Subsequently, the decision part 24 calculates an average distance of distances between start points of the first feature vectors and start points of the second feature vectors in corresponding frames, and an average distance of distances between finish points of the first vectors and finish points of the second vectors in the corresponding frames. The decision part 24 then calculates a value resulting from further averaging the average distances in the corresponding frames over all the frames to be a feature vector distance.

### Step S72

The decision part 24 gives, to each input time-series feature vector normalized in step S6, an action label associated with the reference time-series feature vector that is determined to be most similar in step S71.

The action database 32 stores a default reference time-series feature vector to start a service provided by the action recognition device 1 for a target user. The default reference time-series feature vector is generated through initialization.

The initialization will be described in detail. First, the action recognition device 1 causes a target user to execute trials of a plurality of actions to be decisive candidates. In this case, the action recognition device 1 may present guidance to a mobile terminal of the target user, the guidance stating “Walk”, “Sit”, “Stand up”, “Stoop”, or other message. The trials by the target user may be executed a plurality of times for one action. Next, the action recognition device 1 acquires an image of a trial executed by the target user for a certain action from the camera 4, and calculates time-series feature vectors from the acquired image. The estimation part 22, the calculation part 23, and the decision part 24 execute the calculation of the time-series feature vectors by the aforementioned way. Subsequently, the decision part 24 of the action recognition device 1 associates each calculated time-series feature vector with an action label indicating the action associated with the trial executed by the target user. The decision part 24 thereafter stores, in the action database 32, the time-series feature vector associated with the action label as a reference time-series feature vector. Consequently, a default time-series feature vector is stored in the action database 32.

Although the decision part 24 gives the action label in the initialization or step S72, the present disclosure is not limited thereto, and an operator may give the action label. For instance, the operator may determine an action of a target user from an image from the camera, and the operator may perform an input manipulation of giving an action label indicating the determined action to time-series feature vectors calculated from the image to give the action label to the reference time-series feature vector.

The target user takes various actions in the residence. Thus, atypical action recognizer established through a deep neural network cannot recognize all the actions. For instance, the typical action recognizer generally cannot recognize an action of stooping. In this regard, the embodiment enables recognition of various actions taken by the target user in the residence through the above-described initialization.

Although each input time-series feature vector is compared with all the reference time-series feature vectors stored in the action database 32 in step S72 described above, this is just an example, and each input time-series feature vector may be compared with a specific reference time-series feature vector representative of an associated action. In this case, the decision part 24 may give, to the input time-series feature vector, an action label given to a reference time-series feature vector which is most similar to the input time-series feature vector among the reference time-series feature vectors representative of respective actions. Each of the reference time-series feature vectors representative of the actions is, for example, a reference time-series feature vector resulting from averaging reference time-series feature vectors given the same action label.

The action label is preferably given to a sequence of time-series feature vectors associated with a specific action by the target user from the perspective of recognition of a change in the action. However, it is unpreferable to give an action label to a sequence of time-series feature vectors including time-series feature vectors in a certain period in which an action is not continuous. For instance, a change in the posture of “stooping” is irrelevant to a period in which the action is not continuous, and thus, an action label indicating “stooping” is given to a sequence of time-series feature vectors concerning “stooping”. In contrast, such an action as “opening the door to go out, and coming home one hour later” involves a period in which the action is not continuous, and thus, it is unpreferable to give a specific same action label to the sequence of time-series feature vectors concerning the action. In this respect, in the embodiment, the action “opening the door to go out, and coming home one hour later” is divided into an action section of “opening the door to go out” and an action section of “opening door to enter”, and thus, the action sections are given respective action labels. This prevents giving of one action label to time-series feature vectors including vectors in a period in which an action is not continuous.

### Step S73

The decision part 24 stores, in the action database 32, each input time-series feature vector given the action label in step S72.

### Step S74

The decision part 24 acquires, from the action database 32, a plurality of reference time-series feature vectors (that are example first reference time-series feature vectors) each given the same action label as the action label given to the input time-series feature vector in step S72. Here, the decision part 24 may acquire, from the action database 32, reference time-series feature vectors having been obtained two or more years before among the reference time-series feature vectors given the same action label as the action label given to the input reference time-series feature vector. This enables clear grasping of a change from a past action to a current action for the target user.

### Step S75

The decision part 24 calculates an average time-series feature vector by averaging the reference time-series feature vectors acquired in step S74. This enables one-to-one comparison of the input time-series feature vectors with a plurality of reference time-series feature vectors. No calculation of the average time-series feature vector leads to complicated one-to-two or more comparison of the input time-series feature vectors with the reference time-series feature vectors. Averaging of the reference time-series feature vectors is effective from the perspective of a reduction in noise involved in the reference time-series feature vectors. Specifically, the averaging provides an advantageous effect of reducing an estimation error in node estimation for the reference time-series feature vectors.

The decision part 24 may calculate the average time-series feature vector by calculating an average value of start points 401 of feature vectors L and an average value of finish points 402 thereof for each of frames having the same number for each of the reference time-series feature vectors. In this case, when the number of frames, or the number of data pieces in a time direction, for time-series feature vectors differ from the number of frames for other time-series feature vectors, the decision part 24 may supplement feature vectors through linear interpolation to make the numbers agree with each other. For instance, in a case where an average time-series feature vector is calculated from reference time-series feature vectors associated with ten frames and reference time-series feature vectors associated with thirty frames, no execution of interpolation leads to generation of an average time-series feature point only for ten frames. This means that the twenty frames for associated reference time-series feature vectors remain without being used for calculation of the average time-series feature vector. By contrast, execution of the interpolation enables calculation of an average time-series feature vector for the thirty frames, resulting in achievement of more accurate calculation of the average time-series feature vector.

### Step S76

The decision part 24 generates a comparison result by comparing each input time-series feature vector normalized in step S6 with the average time-series feature vector obtained in step S75. Specifically, the decision part 24 may compare each input time-series feature vector with the average time-series feature vector by calculating a feature vector distance between the input and average time-series feature vectors, as described for step S71.

In other words, the decision part 24 may calculate an average distance of distances between start points of the input time-series feature vectors and start points of the average time-series feature vector in corresponding frames, and an average distance of distances between finish points of the input time-series feature vector and finish points of the average time-series feature vector, and further average the average distances over all the frames to calculate the feature vector distance.

The decision part 24 may generate a comparison result showing “no occurrence of a change in the action” when the feature vector distance is a distance of a threshold or shorter, or generate a comparison result showing “an occurrence of a change in the action” when the feature vector distance exceeds the threshold.

The decision part 24 may compare the average time-series feature vector with the input time-series feature vectors by calculating a statistical value of correlations between feature vectors L of the input time-series feature vectors and feature vectors L of the reference time-series feature vectors in time-series association. A statistical value “a” is expressed with the following equation.

a=R(Ci)

Here, the sign “i” denotes a frame index of each input time-series feature vector and the average time-series feature vector. The sign “Ci” denotes a correlation value between the input time-series feature vector and the average time-series feature vector. The sign “R” denotes a contraction operator for contracting the correlation value Ci. The contraction operator R is an operator for calculating the statistical value “a” serving as a scalar by contracting the correlation value Ci representing time-series data. When contraction computation shows an average, the contraction operator R gives calculation of an average value of correlation values Ci.

A skeletal structure of a target user is defined as a stiff body structure and a chronological change in an action of the target user is taken into consideration. In this case, the movement of the upper body of the target user is similar to a rotational movement about a navel serving as an axis. Therefore, the statistical value “a” calculated on the basis of the equation is effective to express the action of the user with a less order.

For example, the correlation value Ci can take a difference in the vector length of the feature vector L, a difference in the differential value of the vector length of the feature vector L, a difference in the vector angle θ of the feature vector L, or a difference in the vector angular velocity. The vector length indicates a distance from the start point 401 to the finish point 402 of the feature vector L. The differential value of the vector length indicates a change amount of the vector length in adjacent frames. Differential values of the vector length at N-times (“N” is 2 or more” may be adopted in place of the differential value of the vector length. The vector angle θ indicates an angle between a horizontal direction of an image and the feature vector L. The vector angular velocity indicates a time derivative of the vector angle θ and a change amount of the vector angle θ in adjacent frames.

Concerning the contraction operator R, an average value, an average absolute value, a root square value, a reference deviation, or a variance of the correlation value Ci may be calculated. The statistical value “a” results in the average value, the average absolute value, the root square value, the reference deviation, or the variance of the correlation value Ci. In this manner, the time-series data is contracted to a scalar value.

The decision part 24 may decide a change in the action by comparing the statistical value “a” with a threshold. Specifically, the decision part 24 may generate a comparison result showing “no occurrence of a change in the action” when the statistical value “a” is the threshold or lower, or generate a comparison result showing “an occurrence of a change in the action” when the statistical value “a” exceeds the threshold.

Here, when the number of frames for the input time-series feature vectors differs from the number of frames for the average time-series feature vector, the decision part 24 may make the numbers of frames agree with each other through linear interpolation.

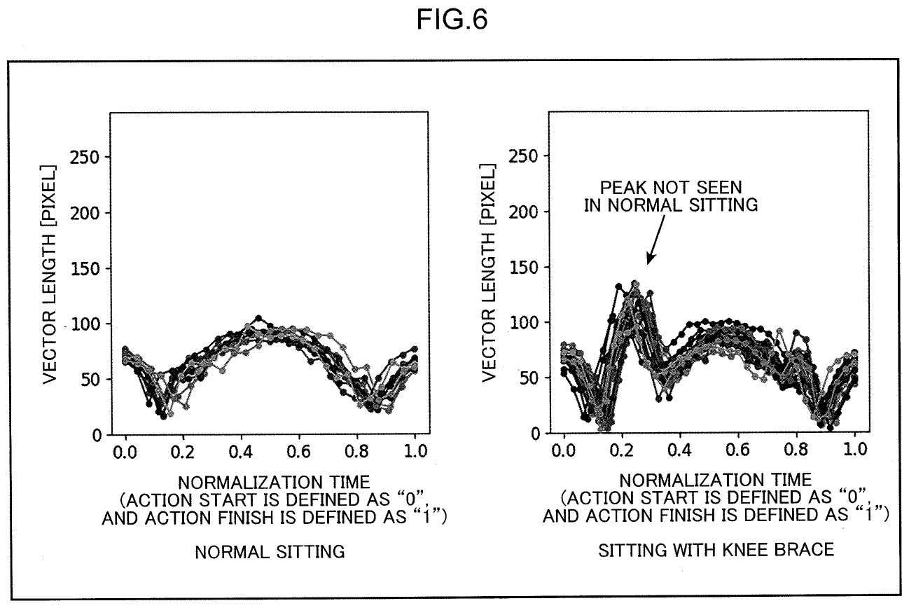

FIG. 6 includes graphs, each showing a chronological change of a vector length of a feature vector L under two different sitting conditions imposed on a subject for an action label “sitting”. The left section in FIG. 6 is a graph showing sitting of the subject without applying any load thereto, that is, normal sitting. The right section in FIG. 6 is graph showing sitting of the subject with a knee brace or sleeve to imitate a physical decline. One polyline in each of the graphs correspond to one time sitting.

Comparing the graphs with each other, the sitting with the knee brace shows a peak at a vector length around a normalization time of 0.2. The peak is not seen in the normal sitting. This confirms a difference between the normal sitting and the sitting with the knee brace. From this perspective, comparison of vector lengths of feature vectors L connecting the gravity center of the trunk and the gravity center of the head leads to, for example, confirmation of a difference in time-series feature vectors before and after the physical decline of the user. This consequently enables recognition of the action of the user to be recognized with a high accuracy even from an image not covering a whole body of the user.

### Step S8

The output part 25 outputs the comparison result generated in step S76 and the action label. The comparison result and the action label are output to, for example, a mobile terminal of the target user. For example, when an occurrence of a change in a walk is decided, the mobile terminal displays a message indicating the occurrence of the change in the action of the walk on a display, or outputs the message from a speaker.

Conclusively, the embodiment achieves recognition of a change in an action per action of a user with a high accuracy even in a case where the camera 4 is arranged in a residence at a camera angle which is unsuitable for sensing. Therefore, the action recognition device 1 in the embodiment is useful for recognizing an action of the user in the residence having many restrictions on the arrangement position of the camera 4.

### Modifications

Although the action recognition device 1 according to one or more aspects of the present disclosure is described on the basis of an embodiment heretofore, the present invention is not limited to the embodiment. Various modifications applied to the embodiment or configurations obtained by combining constituent elements in the embodiment different from each other conceived by a person skilled in the art may be included in the scope of more features of the present disclosure as far as such modifications and configurations do not deviate from the gist of the disclosure. For example, the following modifications are adoptable.
(1) Although the feature vector L is defined to have a start point at the gravity center of the trunk and a finish point at the center of the head in the description above, the present disclosure is not limited thereto. The feature vector L may have a finish point at the gravity center of the trunk and a start point at the gravity center of the head.
(2) The output part 25 outputs a message indicating a change in an action, but this is just an example. The output part may output a message indicating a decline in the action. Alternatively, the output part 5 may output an index indicating a change in the action. The index may take, for example, a feature vector distance or a statistical value as described above.

### INDUSTRIAL APPLICABILITY

An action recognition device according to this disclosure is useful for recognizing a state of a user in a residence.

1. An action recognition device that recognizes an action of a user, comprising:
an acquisition part that acquires an image;
an estimation part that estimates node coordinates of the user from the image acquired by the acquisition part;
a calculation part that calculates, on the basis of the node coordinates, time-series feature vectors each indicating a feature vector connecting a trunk of the user and a head of the user to each other in time series;
a storage part that stores reference time-series feature vectors being the time-series feature vectors to be a reference; and
a decision part that decides the action of the user and a change in the action of the user by comparing input time-series feature vectors being the time-series feature vectors calculated by the calculation part with the reference time-series feature vectors.

2. The action recognition device according to claim 1, wherein,
in the comparing by the decision part, a feature vector constituting the input time-series feature vectors is compared with a feature vector constituting the reference time-series feature vectors in terms of one of a length of the vector, an angle of the vector, a chronological change of the length, and a chronological change of the angle.

3. The action recognition device according to claim 1, wherein the time-series feature vectors are normalized in such a manner that a time is a reference value.

4. The action recognition device according to claim 1, wherein the node coordinates estimated by the estimation part include reliability indicating an estimation accuracy, and
the calculation part calculates a coordinate of the trunk and a coordinate of the head by weighting the node coordinates by using the reliability, and calculates the feature vector on the basis of the calculated coordinate of the trunk and the calculated coordinate of the head.

5. The action recognition device according to claim 1, wherein the reference time-series feature vectors include a plurality of first reference time-series feature vectors each associated with an action label indicating a kind of an action, and
the decision part decides an action label showing the action of the user by comparing the input time-series feature vectors with the first reference time-series feature vectors, calculates an average time-series feature vector by averaging the first reference time-series feature vectors associated with the decided action label, and decides a change in the action of the user by comparing the input time-series feature vectors with the average time-series feature vector.

6. The action recognition device according to claim 1, wherein a feature vector calculated by the calculation part indicates a coordinate of the trunk and a coordinate of the head by using coordinates of the image, and
the decision part executes a parallel translation of the feature vector so that the coordinate of the trunk on the feature vector calculated by the calculation part meets an origin of a coordinate system of the image, and shows the input time-series feature vectors by using the feature vector obtained by the parallel translation.

7. The action recognition device according to claim 1, wherein the decision part normalizes feature vectors so that each of a vertical length and a horizontal length of the image has 1, and shows the time-series feature vectors by using the normalized feature vectors.

8. The action recognition device according to claim 1, wherein,
in a case where a period during which time-series feature vectors are continuously calculated is not shorter than a predetermined period, the calculation part determines the feature vectors within the period as the input time-series feature vectors.

9. The action recognition device according to claim 1, wherein the reference time-series feature vectors represent input time-series feature vectors calculated by the calculation part in past.

10. The action recognition device according to claim 1, wherein the reference time-series feature vectors and the input time-series feature vectors belong to the same user.

11. The action recognition device according to claim 1, wherein the decision part decides an occurrence of a change in the action of the user when a statistical value of correlations between feature vectors of the input time-series feature vectors and feature vectors of the reference time-series feature vectors in time-series association exceeds a threshold.

12. The action recognition device according to claim 1, further comprising an output part that outputs the action and the change in the action that are decided by the decision part.

13. An action recognition method for an action recognition device that recognizes an action of a user, the action recognition method comprising:
acquiring an image;
estimating node coordinates of the user from the acquired image;
calculating, on the basis of the node coordinates, time-series feature vectors each indicating a feature vector connecting a trunk of the user and a head of the user to each other in time series; and
deciding the action of the user and a change in the action of the user by comparing input time-series feature vectors being the calculated time-series feature vectors with reference time-series feature vectors being the time-series feature vectors to be a reference.

14. A non-transitory computer readable recording medium storing an action recognition program for causing a computer to serve as an action recognition device that recognizes an action of a user, the action recognition program comprising:
causing the computer to execute:
acquiring an image;
estimating node coordinates of the user from the acquired image;
calculating, on the basis of the node coordinates, time-series feature vectors each indicating a feature vector connecting a trunk of the user and a head of the user to each other in time series; and
deciding the action of the user and a change in the action of the user by comparing input time-series feature vectors being the calculated time-series feature vectors with reference time-series feature vectors being the time-series feature vectors to be a reference.
